(19) United States
(12) Patent Application Publication
(10) Pub. No.: US 2016/0138856 A1
(43) Pub. Date: May 19, 2016

(54) ACTIVELY CONTROLLED COLD-STORAGE SYSTEM

(71) Applicant: Jeff Wilson, Lebanon, TN (US)

(72) Inventor: Jeff Wilson, Lebanon, TN (US)

(21) Appl. No.: 14/542,124

(22) Filed: Nov. 14, 2014

(51) Int. Cl. F25D 29/00; G06Q 10/08; G05B 15/02

(52) U.S. Cl. CPC F25D 29/00; G05B 15/02; G06Q 10/087

(57) ABSTRACT

A cold-storage management system includes a server that includes a network interface for communicating with at least one bar-code reader having an associated plurality of items that require cold-storage, and a data storage apparatus for storing beginning inventory for each item that requires cold-storage, shipment quantity information for each item that requires cold-storage, usage history for each item that requires cold-storage, usage on-board, low inventory alarm percentage, and order scheduling information for each item that requires cold-storage including date of next scheduled order for each item that requires cold-storage. The server also includes program instructions that, when executed by the processor, are configured to determine a current remaining quantity for at least one item that requires cold-storage by adding beginning inventory and shipment quantity information and subtracting usage history for each item that requires cold-storage currently being utilized and determine an expected remaining quantity for the item that requires cold-storage.

### FIELD

This disclosure relates generally to management of cold-storage facilities.

### BACKGROUND

Conventional cold-storage management systems are inflexible to regards to customer requirements.

### BRIEF DESCRIPTION

In one aspect, a cold-storage system includes at least a partially enclosed structure having at least one access point configured to provide access to the at least one cold-storage unit, wherein the cold-storage unit is at least partially associated with cold-storage unit data and configured to receive and store at least one item that requires cold-storage, which is associated with at least one identification device associated, configured, or programmed with an item that requires cold-storage data that is at least partially associated with the at least one item that requires cold-storage. The cold-storage system is further comprised of at least one local controller that is programmed or configured to generate, receive, and/or transmit at least a portion of at least one of the cold-storage unit data and the item that requires cold-storage data, wherein the at least one local controller is programmed or configured to initiate at least one action based at least partially on at least a portion of at least one of the cold-storage unit data and the item that requires cold-storage data.

In another aspect, a management system includes a server that includes a processor, a network interface for communicating with at least one bar-code reader having an associated plurality of items that require cold-storage, and a data storage apparatus for storing beginning inventory for each item that requires cold-storage, shipment quantity information for each item that requires cold-storage, usage history for each item that requires cold-storage, usage on-board, low inventory alarm percentage, and order scheduling information for each item that requires cold-storage including date of next scheduled order for each item that requires cold-storage. The server also includes program instructions that, when executed by the processor, are configured to determine a current remaining quantity for at least one item that requires cold-storage by adding beginning inventory and shipment quantity information and subtracting usage history for each item that requires cold-storage currently being utilized and determine an expected remaining quantity for the item that requires cold-storage. The program instructions compare the current remaining quantity for the item that requires cold-storage with results of multiplication of the expected remaining quantity and the low inventory alarm percentage, resulting in a comparison and communication with the network interface to selectively send a notification based on the comparison.

In yet another aspect, a method includes defining groups of items that require cold-storage based on stored relationship information, yielding defined groups of items, monitoring a bar-code reader to acquire a bar code of at least one item of the groups of items that require cold-storage. The method is further comprised of an item that determines required cold-storage order information based on the bar-code of the defined groups of items, yielding an identification of a determined item. The method is further comprised of a display of the suggested order schedule having selectable parameters and based on the identification of the determined item that requires cold-storage order information. The method is further comprised of a transmission of a purchase order based on user selections of the suggested order schedule.

In a further aspect, a computer-implemented method for tracking at least one item that requires cold-storage in a tracking system includes at least one computer having a storage medium having stored thereon program instructions, which, when executed by a processor of the computer, causes the processor to detect an entry of the at least one item that requires cold-storage into the tracking system and determine data at least partially associated with the at least one item that requires cold-storage. The data of the item that requires cold-storage at least partially comprises of at least one of the following: Customer/owner data, time data, collection data, purpose data, collector data, location data, cold-storage unit identification data, location data, custody data, results data, compliance data, inventory data, authorization data, access data, user data, status data, alert data, or any combination thereof. The program instructions are able to generate, receive, and/or transmit at least one of the following: Message data, e-mail data, text data, voice data, status data, alert data, or any combination thereof.

### BRIEF DESCRIPTION OF THE DRAWINGS

FIG. 1 is a cold-storage system of active inventory management according to an implementation.

FIG. 2 is a cold-storage network system according to an implementation.

FIG. 3 is a method of managing a cold-storage facility, according to an implementation.

FIG. 4 is a block diagram of a mobile device, according to an implementation.

FIG. 5 illustrates an example of a computer environment useful in the context of the environments of FIG. 1-2, in accordance with an implementation.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the implementations described herein. However, it will be understood by those of ordinary skill in the art that the implementations described herein may be practiced without these specific details. In other instances, well-known methods, procedures and components have not been described in detail so as not to obscure the implementations described herein. Also, the description is not to be considered as limiting the scope of the implementations described herein.

In the following detailed description, reference is made to the accompanying drawings that form a part hereof, and in which is shown by way of illustration specific implementations which may be practiced. These implementations are described in sufficient detail to enable those skilled in the art to practice the implementations, and it is to be understood that other implementations may be utilized and that logical, mechanical, electrical and other changes may be made without departing from the scope of the implementations. The following detailed description is, therefore, not to be taken in a limiting sense.

The detailed description is divided into four sections. In the first section, implementations of apparatus are described. In the second section, implementations of methods are described. In the third section hardware and the operating environments in conjunction with which implementations may be practiced are described. In the fourth section, a conclusion of the detailed description is provided.

### Apparatus Implementations

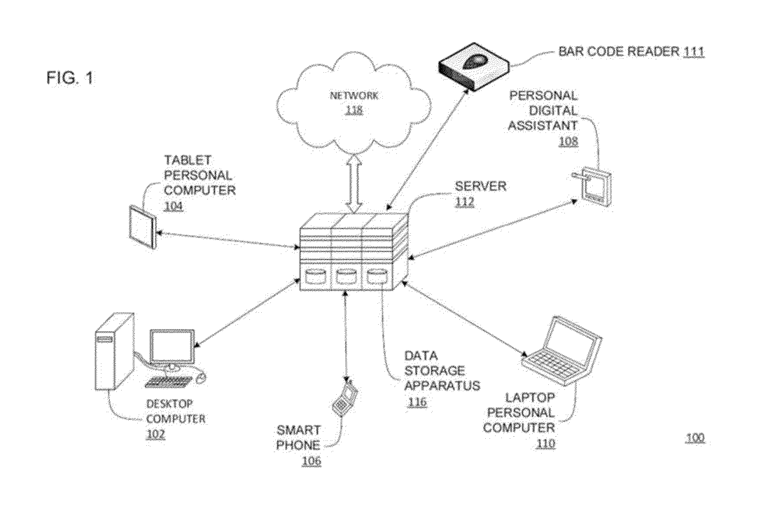

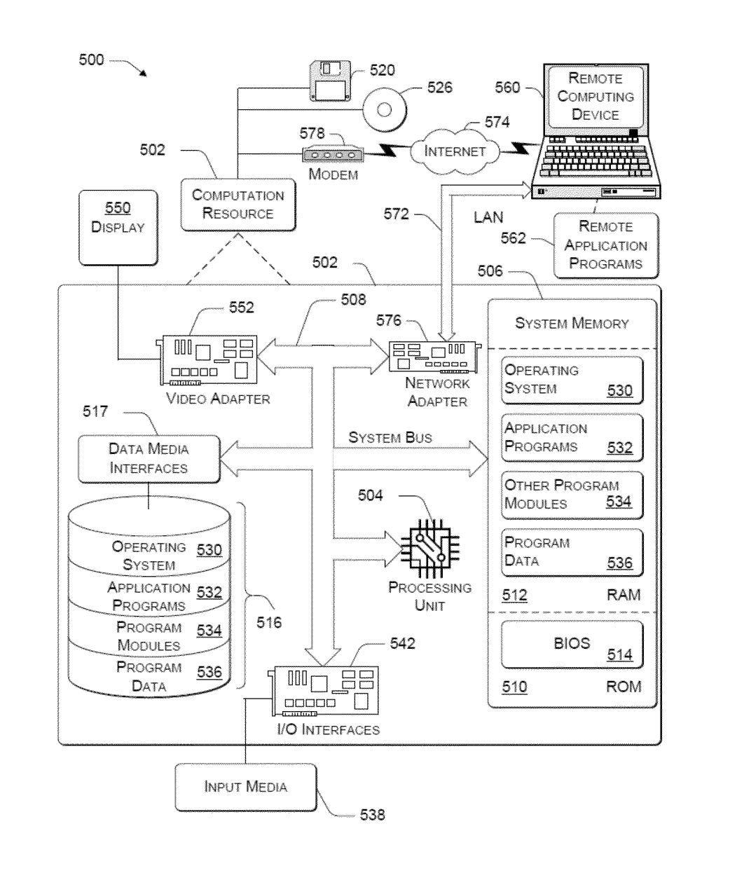

FIG. 1 is a cold-storage system 100 of active inventory management according to an implementation. In FIG. 1, a framework of inventory management systems and methods can be implemented by a client/server architecture utilizing remote HTTP requests or other communication protocols from a desktop computer 102 to communicate with a server 112 which is responsible for substantially all of the processing activity. In some implementations, the server 112 includes at least a processor, or other control circuitry operative to control the operations and performance of the server, data storage apparatus 116 such as memory, semi-permanent memory such as random access memory (RAM), one or more storage mediums including a hard-drive, solid state drive, flash memory, permanent memory such as ROM, any other suitable type of storage component, or any combination thereof, such as such as shown in FIG. 5 and a network interface configured to receive data from, send data to, and otherwise communicate with one or more desktop computers 102 to display content pages on the desktop computers 102. In some implementations, the network 118 is a wide area network such as the Internet and the server 112 is a web server. However, in other implementations the network 118 can be a local area network, Intranet, virtual private network, or any other type of communications infrastructure. In an implementation, the server 112 is a web server having a hard disc data storage apparatus storing executable code that is configured to operate over the Internet in communication with the processor of a web-enabled client 102 to display various web pages of the system on the desktop computer 102. The web server 112 provides customized inventory management procedures that can be implemented in various permutations and combinations for each individual customer in order to present and provide fully customized cold-storage management functions and controls to the customer. Server 112 is never implemented, administered, owned or controlled by the customer; the server 112 is always implemented, administered, owned or controlled by the same organization that owns or controls the cold-storage units 202, which improves reliability and lowers costs of results of the cold-storage system 100.

The plurality of desktop computers 102 can be any electronic device including a processor, data storage apparatus, a display, a user interface device, and a network interface configured to communicate over the network 118 with the server 112 such as a desktop computer 102, tablet personal computer 104, cellular telephone or smart phone 106, personal digital assistant 108, laptop personal computer 110 attached to and/or in direct communication with a bar-code reader 111, for example.

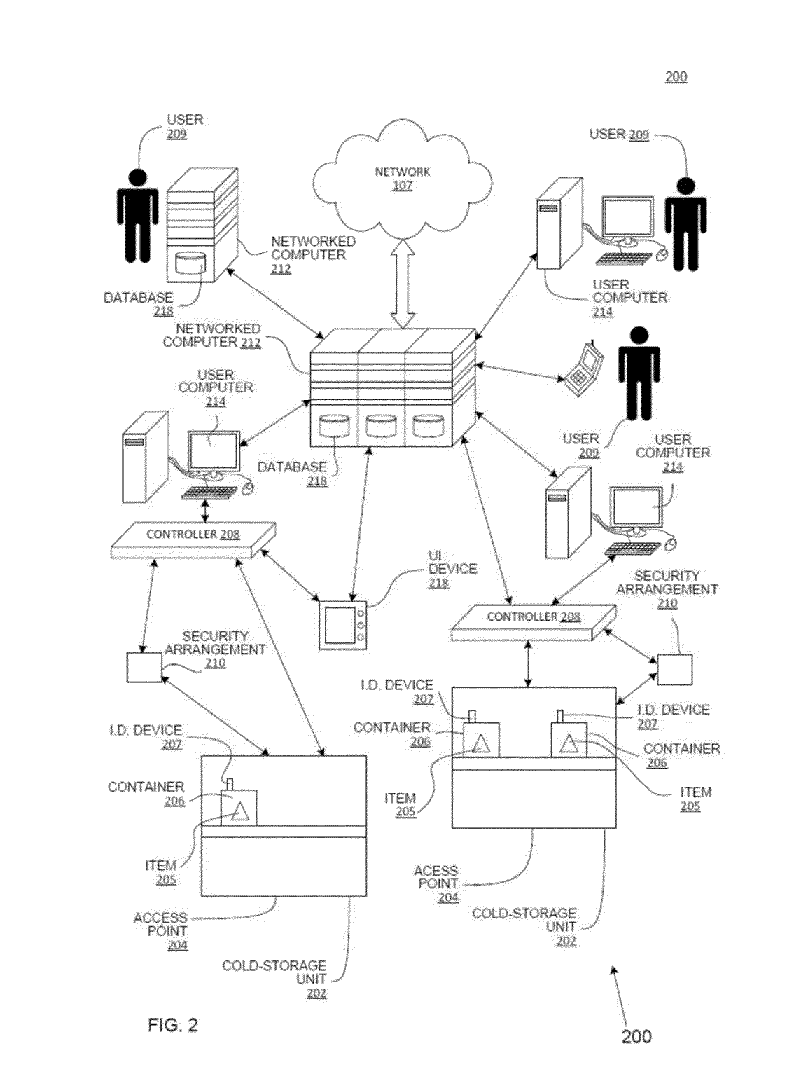

The server 112 of the cold-storage system 100 in some implementations is an Internet-accessible server 112 including a plurality of static and dynamically created web page documents configured to communicate with a database (such as database 218 in FIG. 2) stored in the data storage apparatus 116. At least one web page provides a portal for users, having at least one level of either administrative or customer privileges as stored in the database and as maintained by one or more users with such a level of administrative privileges such as commonly referred to as a system administrator. The content of at least some of the web pages is determined by permissions/privileges, user type (customer or administrator), and/or the specific user associated with a secure login name and password provided by a system administrator and as stored in the database (e.g. 218). Along with setting customer privileges, administrators of the system can populate the database with analyzer site installations as associated with a customer and, item that requires cold-storage information including name, status (shortage, recalled or extent of availability), catalog number, date tracking (e.g. for item expiration), price, type, and description, among other parameters, as discussed in more detail below.

In one non-limiting implementation, and as illustrated in FIG. 2, the item that requires cold-storage management system 200 includes one (and normally multiple) cold-storage units 202 that are formed as an at least partially enclosed structure with at least one access point 204. The cold-storage unit 202 may be in the form of a cabinet, an enclosed box or storage area, a refrigerator, a freezer, a heating unit, or any other container or containment structure. For example, the cold-storage unit 202 may be in form of or include any of the functions and components described in U.S. patent application Ser. No. 13/158,827 (Publication No. US-2011-0285536-A1) and U.S. patent application Ser. No. 12/607,732 (Publication No. US-2010-0191129-A1), each of which is incorporated herein by reference in its entirety. Accordingly, the access point 204 may also take a variety of forms, such as a door, a drawer, a sliding structure, or any other suitable structure or arrangement for permitting access to the internal area of the cold-storage unit 202. In addition, and as discussed in more detail hereinafter, the cold-storage unit 202 is at least partially associated with cold-storage unit data. Still further, the cold-storage unit 202 may be a specially-manufactured or—configured unit, an existing unit, a modified unit, or any combination thereof.

The cold-storage unit 202 is configured or arranged to receive and store (e.g., support) at least one (in some implementations multiple) item that requires cold-storage 202. Further, an identification device 207 is associated with each item that requires cold-storage 205, or a grouping of selected items that require cold-storage 202, and is associated, configured, programmed, and/or pre-programmed with item that requires cold-storage data that is at least partially associated with the item that requires cold-storage 205. The items that require cold-storage 205 may take a variety of forms, including, but not limited to, tissue, blood, urine, biopsy material, body parts, and the like. Accordingly, and in one non-limiting implementation, the item that requires cold-storage 205 is deposited in or stored in a container 206, which may be stored in a large container, if required. Accordingly, the identification device 207 would be attached to or associated with the container 206 storing or containing the item that requires cold-storage 205. Containers 206 can have a variety of sizes and shapes. Accordingly, a corresponding variety of shapes and sizes of identification devices 207 may also be used. In one non-limiting implementation, the identification device 207 is a radio frequency identification tag that is attached to at least a portion of the container 206. This tag may take a variety of forms, as discussed hereinafter.

Cold-storage system 100 actively manages inventory through use of customized inventory management procedures on the server 112 that can be implemented in various permutations and combinations for each individual customer.

As illustrated in the non-limiting implementation of FIG. 2, the item that requires cold-storage management system 200 includes a local controller 208, which is programmed or configured to generate, receive, and/or transmit at least a portion of the cold-storage unit data and item that requires cold-storage data. In addition, this local controller 208 is programmed or configured to initiate at least one action (as discussed hereinafter) based at least partially on the content or nature of the cold-storage unit data and/or the item that requires cold-storage data.

The cold-storage unit data and/or the item that requires cold-storage data may take a variety of forms and at least partially include at least one of the following: customer/owner data, time data, item that requires cold-storage collection data, item that requires cold-storage purpose data, item that requires cold-storage collector data, item that requires cold-storage collection location data, cold-storage unit identification data, location data, custody data, results data, compliance data, inventory data, authorization data, access data, user data, status data, alert data, or any combination thereof. It is some or all of this data that is used in managing and tracking the item that requires cold-storage 205 throughout the various stages of its life cycle.

The customer/owner data may include, but is not limited to, any information or data relating to the customer/owner, such as the customer/owner's name, contact information, diagnostic information, personal information, public information, and the like. The time data may include, but is not limited to, the time a request for an item that requires cold-storage was made, a time of a call to a person, a time of item that requires cold-storage pick-up, a time of item that requires cold-storage 205 drop-off, a time when an item that requires cold-storage 205 was deposited in or removed from a cold-storage unit 202, any time during the various stages in the life cycle of the item that requires cold-storage S, a time associated with delivery or transport, a collection time, and/or any other time-based information or data. The item that requires cold-storage collection data may include, but is not limited to, any information and data related to the initial or subsequent collection of one or more items that require cold-storage 205 from the customer/owner. The item that requires cold-storage purpose data may include, but is not limited to, any information and data related to the reason, as to why the item that requires cold-storage 205 was obtained from the customer/owner. The item that requires cold-storage collector data may include, but is not limited to, any information and data related to the person who collects the item that requires cold-storage 205, the person who receives the item that requires cold-storage 205, the person who deposits or removes the item that requires cold-storage 205 from a cold-storage unit 202, or any other person that has been or will be in custody of the item that requires cold-storage 205. The item that requires cold-storage collection location data may include, but is not limited to, any information and data related to the position or location of the item that requires cold-storage 205 during the various stages of its life cycle. The test data may include, but is not limited to, any information and data related to the testing of the item that requires cold-storage 205.

The cold-storage unit identification data may include, but is not limited to, any information and data related to the cold-storage unit or any of its components. The location data may include, but is not limited to, any information and data related to the physical location or environment of any of the components of the system 200. The custody data may include, but is not limited to, any information or data relating to the custody and/or chain-of-title of the item that requires cold-storage 205. The results data may include, but is not limited to, any information and data related to the testing results or any other analysis directed to the item that requires cold-storage 205. The compliance data may include, but is not limited to, any information and data related to compliance with any rules or regulations associated with any aspect of the life cycle of the item that requires cold-storage 205. The inventory data may include, but is not limited to, any information and data related to inventory management of the item that requires cold-storage 205 and/or the cold-storage units 202. The authorization data may include, but is not limited to, any information and data related to the authorization or security information of any of the users 209, the authorization to handle or control an item that requires cold-storage 205, the authorization to deposit or remove items that require cold-storage 205 from a cold-storage unit 202, and the like. Access data may include, but is not limited to, any information or data relating to access at a cold-storage unit 202, such as through the access point 204.

In another non-limiting implementation, the cold-storage unit 202 is provided with a security arrangement 210 for providing selective access to the cold-storage unit 202, such as through the access point 204. This security arrangement 210 may take a variety of forms, including, but not limited to, a lock, a manual lock, an electronic lock, a magnetic lock, a latching system, a controlled lock, or any other security device or arrangement that can prevent access to the internal area of the cold-storage unit 202. In one non-limiting implementation, the security arrangement 210 is in communication with or otherwise controlled by the local controller 208. In this implementation, the local controller 208 is programmed or configured to unlock the access point 204, e.g., the door, based upon some user 209 interaction with the cold-storage unit 202. In this manner, only an authorized user 209 (or a group or set of authorized users 209) have access to the cold-storage unit 202. Of course, it is envisioned that the cold-storage unit 202 may have multiple access points 204, e.g., multiple doors or drawers, and each of these doors or drawers can be locked and/or unlocked based upon the level or content of the user 209 authorization, e.g., the authorization data. In this manner, a user 209 may have total or only partial access to various areas or components of the cold-storage unit 202.

In addition, and in another non-limiting implementation, the cold-storage unit 202 is in the form of or is in communication with a preexisting unit, such as an existing cabinet, an existing refrigerator, an existing freezer, and existing heating unit, and the like. In this implementation certain components, e.g., the security arrangement 210, may be retrofitted to the existing unit, and the local controller 208 (or, as discussed hereinafter, some other networked computer) may be in direct or indirect communication therewith. Accordingly, some or all of the components and/or features of the system 200 can be used or implemented in connection with an existing cold-storage unit.

In another non-limiting implementation, the cold-storage unit 202 may have multiple accessible and/or controllable portions or areas. Accordingly, the cold-storage unit 202 (or a portion thereof) may be refrigerated, heated, temperature-controlled, humidity-controlled, pressure-controlled, and the like. Such an arrangement is useful when certain types of samples or items that require cold-storage 205 must be kept cold, warm, away from visible light, away from other items that require cold-storage 205, or otherwise in some controlled environment, e.g., a temperature-controlled environment, a humidity-controlled environment, a pressure-controlled environment, a shielded environment, and the like.

One or more networked computers 212 are provided, and these networked computers 212 are in direct or indirect communication with the cold-storage unit 202, such as through the local controller 208. Accordingly, this networked computer 212 may be programmed or configured to initiate one or more actions based upon the cold-storage unit data, the item that requires cold-storage data, and/or any other data generated by or included within the system 200. The networked computer 212 may communicate directly or indirectly and wired or wirelessly with the cold-storage unit 202, the local controller 208, another networked computer 212, the user computer 214, the user interface unit 216, or any other computer or appropriate device in the system 200. For example, and as further illustrated in FIG. 2, the user computer 214 may take the form of a mobile device, such as a smart phone 106, a laptop personal computer 110, a tablet personal computer 104, a notebook, a personal digital assistant 108, and the like. Accordingly, the useful information, such as the above-discussed notifications, statuses, alerts, messages, e-mails, texts, voice data, and the like, can be delivered to any user 209 utilizing any device in the system 200, such as a device operating on or with the network 118. Accordingly, the networked computer 212 may take the place of one or more of the functions of the local controller 208 (or the local controller 208, itself), and generate, receive, and/or transmit any of the above-discussed data and information. Therefore, the functions and features of the local controller 208 and the networked computer 212 can be coextensive, separated, and/or segregated in some implementations manner. Accordingly, the networked computer 212 may control any of the components attached to, included with, or integrated with the cold-storage unit 202.

In another implementation, the networked computer 212 (and/or the local controller 208) includes a database 218 at least partially populated with any of the data and information described above in detail. Further, this database 218 can be maintained in a networked computer 212 in any described manner, such as where the networked computer 212 is a virtual computer, a cloud-based system, a server, a personal computer, a mobile device, and/or any other appropriate computing platform or architecture. In addition, this database 218 can be stored in multiple locations in order to ensure redundancy and for use in certain situations, e.g., an emergency situation where the primary networked computer 212 or server is inoperable or inaccessible. In this manner, the system 200 can continue to operate in any situation and effectively allow for the management of items that require cold-storage 205 throughout their life cycle, which is especially important in a hospital or clinical setting.

In a further implementation, and as also illustrated in FIG. 2, multiple cold-storage units 202 are included in the system 200. In some implementations, these cold-storage units 202 are placed (or may already be present) at various locations, such as the functional locations where the item that requires cold-storage 205 “stops” during its life cycle. In some implementation the multiple cold-storage units 202 can be located at the same location, where each cold-storage unit 202 is directed to a specific type of item that requires cold-storage 205 or satisfies the environmental needs of specific types of items that require cold-storage 205.

### Method Implementations

In the previous section, a system level overview of the operation of an implementation is described. In this section, the particular methods of such an implementation are described by reference to a flowchart. Describing the methods by reference to a flowchart enables one skilled in the art to develop such programs, firmware, or hardware, including such instructions to carry out the methods on suitable computers, executing the instructions from computer-readable media. Similarly, the methods performed by the server computer programs, firmware, or hardware are also composed of computer-executable instructions.

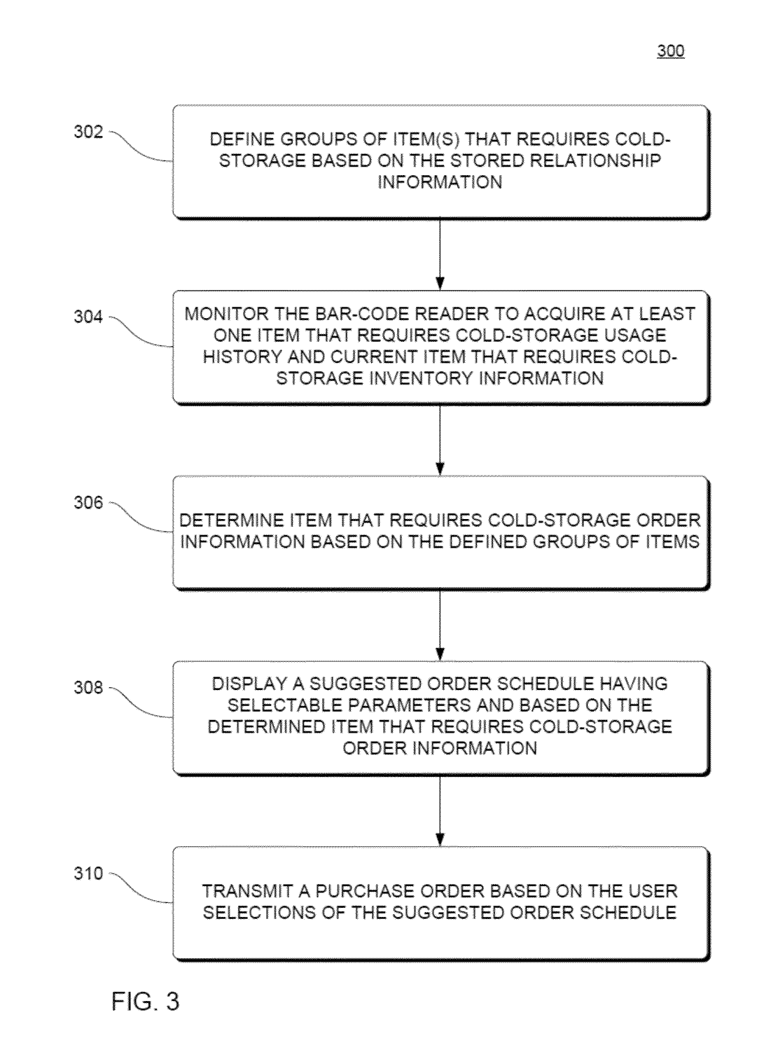

FIG. 3 is a method 300 of managing a cold-storage facility, according to an implementation. In FIG. 3, in a non-limiting implementation, a group of items that require cold-storage are defined by stored relationship data, in block 302. A bar code reader will remotely monitor for items that require cold-storage based on usage history and current item information, in block 304. A scanned bar code will help determine the required cold-storage order information of defined groups of items based on current inventory and usage history, in block 306. A suggested order schedule is then displayed with selectable parameters based on the items or group of item's information, in block 308. The purchase order is then transmitted based on the user selections of the suggested order schedule, in block 310.

### Hardware and Operating Environment

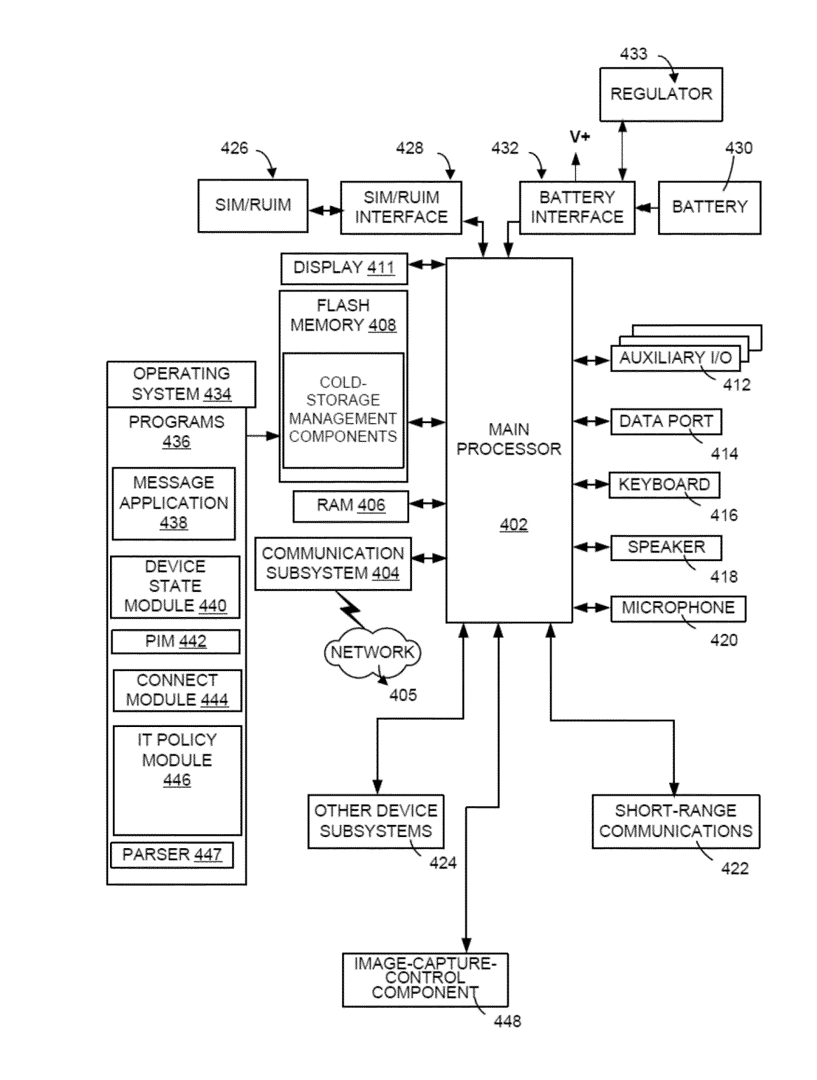

FIG. 4 is a block diagram of a hardware and operating environment in which different implementations can be practiced. The descriptions provide an overview of computer hardware and a suitable computing environment in conjunction with which some implementations can be implemented. Implementations are described in terms of a computer executing computer-executable instructions. However, some implementations can be implemented entirely in computer hardware in which the computer-executable instructions are implemented in read-only memory. Some implementations can also be implemented in client/server computing environments where remote devices that perform tasks are linked through a communications network. Program modules can be located in both local and remote memory storage devices in a distributed computing environment.

The implementations described herein generally relate to a mobile wireless communication device, hereafter referred to as a mobile device, which can be configured according to an IT policy. It should be noted that the term IT policy, in general, refers to a collection of IT policy rules, in which the IT policy rules can be defined as being either grouped or non-grouped and global or per-user. The terms grouped, non-grouped, global and per-user are defined further below. Examples of applicable communication devices include pagers, cellular phones, cellular smart-phones, wireless organizers, personal digital assistants, computers, laptops, handheld wireless communication devices, wirelessly enabled notebook computers and the like.

FIG. 4 is a block diagram of a mobile device 400, according to an implementation. The mobile device is a two-way communication device with advanced data communication capabilities including the capability to communicate with other mobile devices or computer systems through a network of transceiver stations. The mobile device may also have the capability to allow voice communication. Depending on the functionality provided by the mobile device, it may be referred to as a data messaging device, a two-way pager, a cellular telephone with data messaging capabilities, a wireless Internet appliance, or a data communication device (with or without telephony capabilities).

Mobile device 400 is one implementation of hand-held mobile device 108 in FIG. 1. The mobile device 400 includes a number of components such as a main processor 402 that controls the overall operation of the mobile device 400. Communication functions, including data and voice communications, are performed through a communication subsystem 404. The communication subsystem 404 receives messages from and sends messages to wireless networks 405. The wireless networks 405 include a 3G/4G network between tablet personal computer 104, cellular telephone or smart phone 106, personal digital assistant 108, and the server 112 FIG. 1. In other implementations of the mobile device 400, the communication subsystem 404 can be configured in accordance with the Global System for Mobile Communication (GSM), General Packet Radio Services (GPRS), Enhanced Data GSM Environment (EDGE), Universal Mobile Telecommunications Service (UMTS), data-centric wireless networks, voice-centric wireless networks, and dual-mode networks that can support both voice and data communications over the same physical base stations. Combined dual-mode networks include, but are not limited to, Code Division Multiple Access (CDMA) or CDMA2000 networks, GSM/GPRS networks (as mentioned above), and future third-generation (3G) networks like EDGE and UMTS. Some other examples of data-centric networks include Mobitex™ and DataTAC™ network communication systems. Examples of other voice-centric data networks include Personal Communication Systems (PCS) networks like GSM and Time Division Multiple Access (TDMA) systems.

The wireless link connecting the communication subsystem 404 with the wireless network 405 represents one or more different Radio Frequency (RF) channels. With newer network protocols, these channels are capable of supporting both circuit switched voice communications and packet switched data communications.

The main processor 402 also interacts with additional subsystems such as a Random Access Memory (RAM) 406, a flash memory 408, a display 410, an auxiliary input/output (I/O) subsystem 412, a data port 414, a keyboard 416, a speaker 418, a microphone 420, short-range communications 422, other device subsystems 424, and an image-capture-control component 448, such as image transducer in FIG. 12.

Some of the subsystems of the mobile device 400 perform communication-related functions, whereas other subsystems may provide “resident” or on-device functions. By way of example, the display 410 and the keyboard 416 may be used for both communication-related functions, such as entering a text message for transmission over the wireless network 405, and device-resident functions such as a calculator or task list.

The mobile device 400 can transmit and receive communication signals over the wireless network 405 after required network registration or activation procedures have been completed. Network access is associated with a subscriber or user of the mobile device 400. To identify a subscriber, the mobile device 400 requires a SIM/RUIM card 426 (i.e. Subscriber Identity Module or a Removable User Identity Module) to be inserted into a SIM/RUIM interface 428 in order to communicate with a network. The SIM card or RUIM 426 is one type of a conventional “smart card” that can be used to identify a subscriber of the mobile device 400 and to personalize the mobile device 400, among other things. Without the SIM card 426, the mobile device 400 is not fully operational for communication with the wireless network 405. By inserting the SIM card/RUIM 426 into the SIM/RUIM interface 428, a subscriber can access all subscribed services. Services may include: web browsing and messaging such as e-mail, voice mail, Short Message Service (SMS), and Multimedia Messaging Services (MMS). More advanced services may include: point of sale, field service and sales force automation. The SIM card/RUIM 426 includes a processor and memory for storing information. Once the SIM card/RUIM 426 is inserted into the SIM/RUIM interface 428, it is coupled to the main processor 402. In order to identify the subscriber, the SIM card/RUIM 426 can include some user parameters such as an International Mobile Subscriber Identity (IMSI). An advantage of using the SIM card/RUIM 426 is that a subscriber is not necessarily bound by any single physical mobile device. The SIM card/RUIM 426 may store additional subscriber information for a mobile device as well, including datebook (or calendar) information and recent call information. Alternatively, user identification information can also be programmed into the flash memory 408.

The mobile device 400 is a battery-powered device and includes a battery interface 432 for receiving one or more batteries 430. In one or more implementations, the battery 430 can be a smart battery with an embedded microprocessor. The battery interface 432 is coupled to a regulator 433, which assists the battery 430 in providing power V+ to the mobile device 400. Although current technology makes use of a battery, future technologies such as micro fuel cells may provide the power to the mobile device 400.

The mobile device 400 also includes an operating system 434 and software components 436 to 446 which are described in more detail below. The operating system 434 and the software components 436 to 446 that are executed by the main processor 402 are typically stored in a persistent store such as the flash memory 408, which may alternatively be a read-only memory (ROM) or similar storage element (not shown). Those skilled in the art will appreciate that portions of the operating system 434 and the software components 436 to 446, such as specific device applications, or parts thereof, may be temporarily loaded into a volatile store such as the RAM 406. Other components can also be included, such as component shown in FIG. 6-8.

The subset of software applications 436 that control basic device operations, including data and voice communication applications, will normally be installed on the mobile device 400 during its manufacture. Other software applications include a message application 438 that can be any suitable software program that allows a user of the mobile device 400 to transmit and receive electronic messages. Various alternatives exist for the message application 438 as is well known to those skilled in the art. Messages that have been sent or received by the user are typically stored in the flash memory 408 of the mobile device 400 or some other suitable storage element in the mobile device 400. In one or more implementations, some of the sent and received messages may be stored remotely from the device 400 such as in a data store of an associated host system with which the mobile device 400 communicates.

The software applications can further include a device state module 440, a Personal Information Manager (PIM) 442, and other suitable modules (not shown). The device state module 440 provides persistence, i.e. the device state module 440 ensures that important device data is stored in persistent memory, such as the flash memory 408, so that the data is not lost when the mobile device 400 is turned off or loses power.

The PIM 442 includes functionality for organizing and managing data items of interest to the user, such as, but not limited to, e-mail, contacts, calendar events, voice mails, appointments, and task items. A PIM application has the ability to transmit and receive data items via the wireless network 405. PIM data items may be seamlessly integrated, synchronized, and updated via the wireless network 405 with the mobile device subscriber's corresponding data items stored and/or associated with a host computer system. This functionality creates a mirrored host computer on the mobile device 400 with respect to such items. This can be particularly advantageous when the host computer system is the mobile device subscriber's office computer system.

The mobile device 400 also includes a connect module 444, and an IT policy module 446. The connect module 444 implements the communication protocols that are required for the mobile device 400 to communicate with the wireless infrastructure and any host system, such as an enterprise system, with which the mobile device 400 is authorized to interface.

The connect module 444 includes a set of APIs that can be integrated with the mobile device 400 to allow the mobile device 400 to use any number of services associated with the enterprise system. The connect module 444 allows the mobile device 400 to establish an end-to-end secure, authenticated communication pipe with the host system. A subset of applications for which access is provided by the connect module 444 can be used to pass IT policy commands from the host system to the mobile device 400. This can be done in a wireless or wired manner. These instructions can then be passed to the IT policy module 446 to modify the configuration of the device 400. Alternatively, in some cases, the IT policy update can also be done over a wired connection.

The IT policy module 446 receives IT policy data that encodes the IT policy. The IT policy module 446 then ensures that the IT policy data is authenticated by the mobile device 400. The IT policy data can then be stored in the flash memory 408 in its native form. After the IT policy data is stored, a global notification can be sent by the IT policy module 446 to all of the applications residing on the mobile device 400. Applications for which the IT policy may be applicable then respond by reading the IT policy data to look for IT policy rules that are applicable.

The IT policy module 446 can include a parser 447, which can be used by the applications to read the IT policy rules. In some cases, another module or application can provide the parser. Grouped IT policy rules, described in more detail below, are retrieved as byte streams, which are then sent (recursively) into the parser to determine the values of each IT policy rule defined within the grouped IT policy rule. In one or more implementations, the IT policy module 446 can determine which applications are affected by the IT policy data and transmit a notification to only those applications. In either of these cases, for applications that are not being executed by the main processor 402 at the time of the notification, the applications can call the parser or the IT policy module 446 when they are executed to determine if there are any relevant IT policy rules in the newly received IT policy data.

All applications that support rules in the IT Policy are coded to know the type of data to expect. For example, the value that is set for the “WEP User Name” IT policy rule is known to be a string; therefore the value in the IT policy data that corresponds to this rule is interpreted as a string. As another example, the setting for the “Set Maximum Password Attempts” IT policy rule is known to be an integer, and therefore the value in the IT policy data that corresponds to this rule is interpreted as such.

After the IT policy rules have been applied to the applicable applications or configuration files, the IT policy module 446 sends an acknowledgement back to the host system to indicate that the IT policy data was received and successfully applied.

Other types of software applications can also be installed on the mobile device 400. These software applications can be third party applications, which are added after the manufacture of the mobile device 400. Examples of third party applications include games, calculators, utilities, etc.

The additional applications can be loaded onto the mobile device 400 through at least one of the wireless network 405, the auxiliary I/O subsystem 412, the data port 414, the short-range communications subsystem 422, or any other suitable device subsystem 424. This flexibility in application installation increases the functionality of the mobile device 400 and may provide enhanced on-device functions, communication-related functions, or both. For example, secure communication applications may enable electronic commerce functions and other such cold-storage management transactions to be performed using the mobile device 400.

The data port 414 enables a subscriber to set preferences through an external device or software application and extends the capabilities of the mobile device 400 by providing for information or software downloads to the mobile device 400 other than through a wireless communication network. The alternate download path may, for example, be used to load an encryption key onto the mobile device 400 through a direct and thus reliable and trusted connection to provide secure device communication.

The data port 414 can be any suitable port that enables data communication between the mobile device 400 and another computing device. The data port 414 can be a serial or a parallel port. In some instances, the data port 414 can be a USB port that includes data lines for data transfer and a supply line that can provide a charging current to charge the battery 430 of the mobile device 400.

The short-range communications subsystem 422 provides for communication between the mobile device 400 and different systems or devices, without the use of the wireless network 405. For example, the subsystem 422 may include an infrared device and associated circuits and components for short-range communication. Examples of short-range communication standards include standards developed by the Infrared Data Association (IrDA), Bluetooth, and the 802.11 family of standards developed by IEEE.

In use, a received signal such as a text message, an e-mail message, or web page download will be processed by the communication subsystem 404 and input to the main processor 402. The main processor 402 will then process the received signal for output to the display 410 or alternatively to the auxiliary I/O subsystem 412. A subscriber may also compose data items, such as e-mail messages, for example, using the keyboard 416 in conjunction with the display 410 and possibly the auxiliary I/O subsystem 412. The auxiliary subsystem 412 may include devices such as: a touch screen, mouse, track ball, infrared fingerprint detector, or a roller wheel with dynamic button pressing capability. The keyboard 416 is preferably an alphanumeric keyboard and/or telephone-type keypad. However, other types of keyboards may also be used. A composed item may be transmitted over the wireless network 405 through the communication subsystem 404.

For voice communications, the overall operation of the mobile device 400 is substantially similar, except that the received signals are output to the speaker 418, and signals for transmission are generated by the microphone 420. Alternative voice or audio I/O subsystems, such as a voice message recording subsystem, can also be implemented on the mobile device 400. Although voice or audio signal output is accomplished primarily through the speaker 418, the display 410 can also be used to provide additional information such as the identity of a calling party, duration of a voice call, or other voice call related information.

FIG. 5 illustrates an example of a computer environment 500 useful in the context of the environments of FIG. 1-2, in accordance with an implementation. The computer environment 500 includes a computation resource 502 capable of implementing the processes described herein. It will be appreciated that other devices can alternatively used that include more components, or fewer components, than those illustrated in FIG. 5.

The illustrated operating environment 500 is only one example of a suitable operating environment, and the example described with reference to FIG. 5 is not intended to suggest any limitation as to the scope of use or functionality of the implementations of this disclosure. Other well-known computing systems, environments, and/or configurations can be suitable for implementation and/or application of the subject matter disclosed herein.

The computation resource 502 includes one or more processors or processing units 504, a system memory 506, and a bus 508 that couples various system components including the system memory 506 to processor(s) 504 and other elements in the environment 500. The bus 508 represents one or more of any of several types of bus structures, including a memory bus or memory controller, a peripheral bus, an accelerated graphics port and a processor or local bus using any of a variety of bus architectures, and can be compatible with SCSI (small computer system interconnect), or other conventional bus architectures and protocols.

The system memory 506 includes nonvolatile read-only memory (ROM) 510 and random access memory (RAM) 512, which can or can not include volatile memory elements. A basic input/output system (BIOS) 514, containing the elementary routines that help to transfer information between elements within computation resource 502 and with external items, typically invoked into operating memory during start-up, is stored in ROM 510.

The computation resource 502 further can include a non-volatile read/write memory 516, represented in FIG. 5 as a hard disk drive, coupled to bus 508 via a data media interface 517 (e.g., a SCSI, ATA, or other type of interface); a magnetic disk drive (not shown) for reading from, and/or writing to, a removable magnetic disk 520 and an optical disk drive (not shown) for reading from, and/or writing to, a removable optical disk 526 such as a CD, DVD, or other optical media.

The non-volatile read/write memory 516 and associated computer-readable media provide nonvolatile storage of computer-readable instructions, data structures, program modules and other data for the computation resource 502. Although the exemplary environment 500 is described herein as employing a non-volatile read/write memory 516, a removable magnetic disk 520 and a removable optical disk 526, it will be appreciated by those skilled in the art that other types of computer-readable media which can store data that is accessible by a computer, such as magnetic cassettes, FLASH memory cards, random access memories (RAMS), read only memories (ROM), and the like, can also be used in the exemplary operating environment.

A number of program modules can be stored via the non-volatile read/write memory 516, magnetic disk 520, optical disk 526, ROM 510, or RAM 512, including an operating system 530, one or more application programs 532, other program modules 534 and program data 536. Examples of computer operating systems conventionally employed for some types of three-dimensional and/or two-dimensional medical image data include the NUCLEUS® operating system, the LINUX® operating system, and others, for example, providing capability for supporting application programs 532 using, for example, code modules written in the C++® computer programming language.

A user can enter commands and information into computation resource 502 through input devices such as input media 538 (e.g., keyboard/keypad, tactile input or pointing device, mouse, foot-operated switching apparatus, joystick, touchscreen or touchpad, microphone, antenna etc.). Such input devices 538 are coupled to the processing unit 504 through a conventional input/output interface 542 that is, in turn, coupled to the system bus. A monitor 550 or other type of display device is also coupled to the system bus 508 via an interface, such as a video adapter 552.

The computation resource 502 can include capability for operating in a networked environment (as illustrated in FIG. 1, for example) using logical connections to one or more remote computers, such as a remote computer 560. The remote computer 560 can be a personal computer, a server, a router, a network PC, a peer device or other common network node, and typically includes many or all of the elements described above relative to the computation resource 502. In a networked environment, program modules depicted relative to the computation resource 502, or portions thereof, can be stored in a remote memory storage device such as can be associated with the remote computer 560. By way of example, remote application programs 562 reside on a memory device of the remote computer 560. The logical connections represented in FIG. 5 can include interface capabilities, a storage area network (SAN, not illustrated in FIG. 5), local area network (LAN) 572 and/or a wide area network (WAN) 574, but can also include other networks.

Such networking environments are commonplace in modern computer systems, and in association with intranets and the Internet. In certain implementations, the computation resource 502 executes an Internet Web browser program (which can optionally be integrated into the operating system 530), such as the “Internet Explorer®” Web browser manufactured and distributed by the Microsoft Corporation of Redmond, Wash.

When used in a LAN-coupled environment, the computation resource 502 communicates with or through the local area network 572 via a network interface or adapter 576. When used in a WAN-coupled environment, the computation resource 502 typically includes interfaces, such as a modem 578, or other apparatus, for establishing communications with or through the WAN 574, such as the Internet. The modem 578, which can be internal or external, is coupled to the system bus 508 via a serial port interface.

In a networked environment, program modules depicted relative to the computation resource 502, or portions thereof, can be stored in remote memory apparatus. It will be appreciated that the network connections shown are exemplary, and other means of establishing a communications link between various computer systems and elements can be used.

A user of a computer can operate in a networked environment 100 and 200 using logical connections to one or more remote computers, such as a remote computer 560, which can be a personal computer, a server, a router, a network PC, a peer device or other common network node. Typically, a remote computer 560 includes many or all of the elements described above relative to the computer 500 of FIG. 5.

The computation resource 502 typically includes at least some form of computer-readable media. Computer-readable media can be any available media that can be accessed by the computation resource 502. By way of example, and not limitation, computer-readable media can comprise computer storage media and communication media.

Computer storage media include volatile and nonvolatile, removable and non-removable media, implemented in any method or technology for storage of information, such as computer-readable instructions, data structures, program modules or other data. The term “computer storage media” includes, but is not limited to, RAM, ROM, EEPROM, FLASH memory or other memory technology, CD, DVD, or other optical storage, magnetic cassettes, magnetic tape, magnetic disk storage or other magnetic storage devices, or any other media which can be used to store computer-intelligible information and which can be accessed by the computation resource 502.

Communication media typically embodies computer-readable instructions, data structures and/or program modules.

By way of example, and not limitation, communication media include wired media, such as wired network or direct-wired connections, and wireless media, such as acoustic, RF, infrared and other wireless media. The scope of the term computer-readable media includes combinations of any of the above.

More specifically, in the computer-readable program implementation, the programs can be structured in an object-orientation using an object-oriented language such as Java, Smalltalk or C++, and the programs can be structured in a procedural-orientation using a procedural language such as COBOL or C. The software components communicate in any of a number of means that are well-known to those skilled in the art, such as application program interfaces (API) or interprocess communication techniques such as remote procedure call (RPC), common object request broker architecture (CORBA), Component Object Model (COM), Distributed Component Object Model (DCOM), Distributed System Object Model (DSOM) and Remote Method Invocation (RMI). The components execute on as few as one computer as in computer environment 500 in FIG. 5, or on at least as many computers as there are components.

### Implementation Scenarios

The system, methods and apparatus described above is applicable to a variety of related applications, including Internet-based transactions.

The system as described above applies equally well to transactions carried out over the Internet. In this application, the on-line server 112 merely sends information to a browser extension or other application on the user's computer through which the customer is executing a purchase or other transaction. This information can include cold-storage management or similar information of the server 112 sufficient to allow the user to initiate an electronic cold-storage management transaction to pay the server 112, the amount due for the transaction, and a unique transaction identification code that allows the customer to make payment to the server 112 with such payment associated with the particular transaction. Receipt of this information might then activate the user's electronic cold-storage management application or web site, and ask the user to confirm payment of that amount to that server 112, using the user's PIN or other security identification information to confirm authorization of the payment. The cold-storage management application then instructs the customer to initiate payment to the server 112 exactly as described above for the Point of Sale application. Similarly, the payment by the customer to the server 112 and confirmation/approval can proceed as described for the PoS application.

System, methods and apparatus described herein can be applied in which the customer print a QR code on the item requiring cold-storage of the customer. The customer captures this QR code 103 on a smart phone 108, launching the cold-storage management application, which presents the customer with the name of the cold-storage management company. The user can then complete the authorization by entering a PIN code. The remainder of the transaction can be the same as above, with the customer issuing payment to the cold-storage management company or other establishment.

System, methods and apparatus described herein uses and builds upon on-line electronic cold-storage management technology. Conventional computer-based electronic cold-storage management applications generally rely on a user name and password to authorize the user to do electronic transactions. Handheld applications, such as smartphone cold-storage management apps, can rely simply on a user's PIN. In some implementations, the system, methods and apparatus described herein simply use the same verifications. To the extent that customers start moving to more secure identity verification systems, such as token cards, the system, methods and apparatus described herein piggy-backs and as a result experience the same level of security improvement (and convenience diminution) as other uses of on-line cold-storage management.

### CONCLUSION

A product/service approval system is described. A technical effect is active inventory management in which customized inventory management procedures are implemented for each individual customer. Although specific implementations have been illustrated and described herein, it will be appreciated by those of ordinary skill in the art that any arrangement which is calculated to achieve the same purpose may be substituted for the specific implementations shown. This disclosure is intended to cover any adaptations or variations. For example, although described in procedural terms, one of ordinary skill in the art will appreciate that implementations can be made in an object-oriented design environment or any other design environment that provides the required relationships.

In particular, one of skill in the art will readily appreciate that the names of the methods and apparatus are not intended to limit implementations. Furthermore, additional methods and apparatus can be added to the components, functions can be rearranged among the components, and new components to correspond to future enhancements and physical devices used in implementations can be introduced without departing from the scope of implementations. One of skill in the art will readily recognize that implementations are applicable to future image transducers, new orientation detection components, and different orientations.

The terminology used in this application is meant to include all wireless mobile devices, orientation detection components and image transducers and alternate technologies which provide the same functionality as described herein.

1. A cold-storage system, comprising:
at least one cold-storage unit comprising:
an at least partially enclosed structure having at least one access point configured to provide access to the at least one cold-storage unit, wherein the at least one cold-storage unit is at least partially associated with cold-storage unit data and configured to receive and store at least one item that requires cold-storage, which is associated with at least one identification device associated, configured, or programmed with item that requires cold-storage data at least partially associated with the at least one item that requires cold-storage; and
at least one local controller programmed or configured to generate, receive, and/or transmit at least a portion of at least one of the cold-storage unit data and the item that requires cold-storage data, wherein the at least one local controller is programmed or configured to initiate at least one action based at least partially on at least a portion of at least one of the cold-storage unit data and the item that requires cold-storage data.

2. The cold-storage system of claim 1, wherein the at least one item that requires cold-storage is at least partially positioned in a container, and the at least one identification device is associated with the container.

3. The cold-storage system of claim 2, wherein the at least one identification device is a radio frequency identification tag attached to at least a portion of the container.

4. The cold-storage system of claim 1, wherein at least one of the cold-storage unit data and the item that requires cold-storage data at least partially comprises at least one of the following:
customer/owner data,
time data,
item that requires cold-storage collection data,
item that requires cold-storage purpose data,
item that requires cold-storage collector data,
item that requires cold-storage collection location data,
cold-storage unit identification data,
location data,
custody data,
results data,
compliance data,
inventory data,
authorization data,
access data,
user data,
status data,
alert data, or
any combination thereof.

5. The cold-storage system of claim 1, wherein the at least one cold-storage unit comprises:
a security arrangement configured to provide selective access to the at least one cold-storage unit through the at least one access point.

6. The cold-storage system of claim 5, wherein the at least one local controller is in communication with the at least one security arrangement and programmed or configured to unlock the at least one access point based at least partially upon user interaction with the at least one cold-storage unit.

7. The cold-storage system of claim 1, wherein at least a portion of the at least one cold-storage unit is at least one of the following:
refrigerated, heated, temperature controlled, humidity controlled, pressure controlled, or any combination thereof.

8. The cold-storage system of claim 1, wherein the at least one local controller is in communication with at least one user interface unit attached to or integrated with the at least one cold-storage unit.

9. The cold-storage system of claim 1, wherein the at least one local controller is programmed or configured to generate, receive, and/or transmit at least one of the following:
at least a portion of the cold-storage unit data, at least a portion of the item that requires cold-storage data, message data, e-mail data, text data, voice data, status data, alert data, or any combination thereof.

10. The cold-storage system of claim 1, wherein the at least one local controller is programmed or configured to generate, receive, and/or transmit at least one of the following:
a notification relating an item that requires cold-storage custody chain;
a notification relating to access to the at least one cold-storage unit;
a notification that the at least one cold-storage unit has been accessed;
a notification that the at least one cold-storage unit has been accessed and at least one other action or inaction has been detected;
a notification comprising at least a portion of at least one of the cold-storage unit data and the item that requires cold-storage data;
a notification that at least one item that requires cold-storage has been placed in or removed from the at least one cold-storage unit;
a notification that at least one item that requires cold-storage has been placed in or removed from the at least one cold-storage unit and at least one other action or inaction has been detected;
a notification including time information relating to the at least one item that requires cold-storage; and
a notification including results or test information relating to the at least one item that requires cold-storage; or
any combination thereof.

11. The cold-storage system of claim 1, further comprising:
at least one networked computer in direct or indirect communication with the at least one cold-storage unit and configured to receive at least a portion of at least one of the cold-storage unit data and the item that requires cold-storage data; wherein the at least one networked computer is programmed or configured to initiate at least one action based at least partially on at least one of the cold-storage unit data and the item that requires cold-storage data.

12. The cold-storage system of claim 11, wherein the at least one networked computer is configured to generate, receive, and/or transmit at least one of the following:
at least a portion of the cold-storage unit data, at least a portion of the item that requires cold-storage data, message data, e-mail data, text data, voice data, status data, alert data, or any combination thereof.

13. A cold-storage system comprising:
at least one cold-storage unit comprising an at least partially enclosed structure having at least one access point configured to provide access to the at least one cold-storage unit, wherein the at least one cold-storage unit is at least partially associated with cold-storage unit data and configured to receive and store at least one item that requires cold-storage, which is associated with at least one identification device associated, configured, or programmed with item that requires cold-storage data at least partially associated with the at least one item that requires cold-storage; and
at least one networked computer in direct or indirect communication with the at least one cold-storage unit and configured to receive at least a portion of at least one of the cold-storage unit data and the item that requires cold-storage data, wherein the at least one networked computer is programmed or configured to initiate at least one action based at least partially on at least a portion of at least one of the cold-storage unit data and the item that requires cold-storage data.

14. The cold-storage system of claim 13, wherein the at least one cold-storage unit further comprises:
at least one local controller programmed or configured to generate, receive, and/or transmit at least a portion of at least one of the cold-storage unit data and the item that requires cold-storage data, wherein the at least one local controller is programmed or configured to initiate at least one action based at least partially on at least one of the cold-storage unit data and the item that requires cold-storage data.

15. The cold-storage system of claim 14, wherein the at least one local controller is programmed or configured to generate, receive, and/or transmit at least one of the following:
at least a portion of the cold-storage unit data, at least a portion of the item that requires cold-storage data, message data, e-mail data, text data, voice data, status data, alert data, or any combination thereof.

16. The cold-storage system of claim 13, wherein the at least one networked computer is configured to generate, receive, and/or transmit at least one of the following:
at least a portion of the cold-storage unit data,
at least a portion of the item that requires cold-storage data,
message data,
e-mail data,
text data,
voice data,
status data,
alert data, or
any combination thereof.

17. The cold-storage system of claim 13, wherein the at least one networked computer is programmed or configured to generate, receive, and/or transmit at least one of the following:
a notification relating an item that requires cold-storage custody chain;
a notification relating to access to the at least one cold-storage unit;
a notification that the at least one cold-storage unit has been accessed;
a notification that the at least one cold-storage unit has been accessed and at least one other action or inaction has been detected;
a notification comprising at least a portion of at least one of the cold-storage unit data and the item that requires cold-storage data;
a notification that at least one item that requires cold-storage has been placed in or removed from the at least one cold-storage unit;
a notification that at least one item that requires cold-storage has been placed in or removed from the at least one cold-storage unit and at least one other action or inaction has been detected;
a notification including time information relating to the at least one item that requires cold-storage;
a notification including results or test information relating to the at least one item that requires cold-storage; or
any combination thereof.

18. The cold-storage system of claim 13, wherein the at least one networked computer comprises at least one database at least partially populated with at least one of the following:
customer/owner data,
time data,
item that requires cold-storage collection data,
item that requires cold-storage purpose data,
item that requires cold-storage collector data,
item that requires cold-storage collection location data,
cold-storage unit identification data,
location data,
custody data,
results data,
compliance data,
inventory data,
authorization data,
access data,
user data,
message data,
e-mail data,
text data,
voice data,
status data,
alert data,
or any combination thereof.

19. The cold-storage system of claim 13, further comprising:
a plurality of cold-storage units, each having at least one local controller programmed or configured to control at least one function of the at least one cold-storage unit, wherein the plurality of cold-storage units are in direct or indirect communication over a network.

20. A management and notification system comprising:
a server including:
a processor;
a network interface for communicating with at least one bar-code reader having an associated plurality of items that require cold-storage;
data storage apparatus for storing beginning inventory for each item that requires cold-storage, shipment quantity information for each item that requires cold-storage, usage history for each item that requires cold-storage, usage on-board, low inventory alarm percentage, and order scheduling information for each item that requires cold-storage including date of next scheduled order for each item that requires cold-storage; and
program instructions that, when executed by the processor, are configured to:
determine a current remaining quantity for at least one item that requires cold-storage by adding beginning inventory and shipment quantity information and subtracting usage history for each item that requires cold-storage currently being utilized; and
determine an expected remaining quantity for the item that requires cold-storage;
compare the current remaining quantity for the item that requires cold-storage with results of multiplication of the expected remaining quantity and the low inventory alarm percentage, resulting in a comparison; and
communicate with the network interface to selectively send a notification based on the comparison.

21. The inventory management and notification system of claim 20 wherein the data storage apparatus further includes:
a portal accessible by a plurality of remote computers and associated authenticated users through the network interface wherein the data storage apparatus is further configured to store at least one interface accessible through the portal for selecting one or more parameters selected from the group consisting of a user name, a login name, password, an entity represented, a bar-code reader type, a user address, a name of person to be notified and a method of notification.

22. The inventory management and notification system of claim 21 wherein the notification is selected from at least one of the group consisting of SMS, MMS, electronic mail, and automated telephone call.

23. An order management system, comprising:
a server including:
a processor;
a network interface for communicating with at least one bar-code reader having an associated plurality of items that require cold-storage;
data storage apparatus for storing:
relationship information for each item that requires cold-storage;
current inventory for each item that requires cold-storage;
usage history for each item that requires cold-storage; and
an order management module including program instructions that, when executed by the processor, are configured to suggest an item that requires cold-storage order schedule based on the relationship information, current inventory, and usage history wherein the item that requires cold-storage order schedule includes a plurality of item that requires cold-storage buckets.

24. The order management system of claim 23 wherein the data storage apparatus is further configured to:
store at least one of a description of the item that requires cold-storage, catalog number, pending ship quantity, and suggested order quantity.

25. The order management system of claim 23 wherein the data storage apparatus further includes:
a portal accessible by a plurality of remote computers and associated authenticated users through the network interface wherein the data storage apparatus is further configured to store at least one interface accessible through the portal for selecting one or more parameters selected from at least one of the group consisting of customer information, payment information, items to be ordered, quantity of items to be ordered, order cycle, workdays between order, safety stock days, workdays per week, and number of assays served for each item that requires cold-storage.

26. The order management system of claim 25 wherein the order management module further includes:
program instructions configured to display, in the at least one interface accessible through the portal, a determined order information in one or more user selectable parameters selected from a group consisting of groups of item that requires cold-storages, suggested order quantity of each item that requires cold-storage in each group of item that requires cold-storage, and timing of purchase.

27. The order management system of claim 26 wherein the order management module further includes:
program instructions configured to communicate, using the network interface, a purchase order to a supplier of item that requires cold-storages based on the user selections.

28. The order management system of claim 26 wherein the data storage apparatus is further configured to
store operational history of each bar-code reader and item that requires cold-storage ordering history associated with each bar-code reader.

29. A method comprising:
defining groups of items that require cold-storage based on stored relationship information, yielding defined groups of items;
monitoring a bar-code reader to acquire a bar code of at least one item of the groups of items that require cold-storage;
determining an item that requires cold-storage order information based on the bar-code of the defined groups of items, yielding an identification of a determined item;
displaying a suggested order schedule having selectable parameters and based on the identification of the determined item that requires cold-storage order information; and
transmitting a purchase order based on user selections of the suggested order schedule.

30. The method of claim 29 wherein the monitoring remotely further comprise:
acquiring operational history information and ordering history information of the item that requires cold-storage.

31. The method of claim 29 wherein the selectable parameters comprise:
at least one of customer information,
payment information, items to be ordered,
quantity of items to be ordered,
order cycle,
workdays between order,
safety stock days,
workdays per week,
number of assays served for each item that requires cold-storage,
order quantity of each item that requires cold-storage, and
timing of purchase.

32. A computer-implemented method for tracking at least one item that requires cold-storage in a tracking system, comprising:
on at least one computer having a storage medium having stored thereon program instructions, which, when executed by a processor of the computer, cause the processor to:
detect an entry of the at least one item that requires cold-storage into the tracking system; and
determine item that requires cold-storage data at least partially associated with the at least one item that requires cold-storage, wherein the item that requires cold-storage data at least partially comprises at least one of the following:
customer/owner data,
time data,
item that requires cold-storage collection data,
item that requires cold-storage purpose data,
item that requires cold-storage collector data,
item that requires cold-storage collection location data,
cold-storage unit identification data,
location data,
custody data,
results data,
compliance data,
inventory data,
authorization data,
access data,
user data,
status data,
alert data,
or any combination thereof; and
based at least partially on at least a portion of the item that requires cold-storage data, generate, receive, and/or transmit at least one of the following:
at least a portion of the item that requires cold-storage data,
message data,
e-mail data,
text data,
voice data,
status data,
alert data,
or any combination thereof.
